(19) United States
(12) Patent Application Publication
(10) Pub. No.: US 2020/0132619 A1
(43) Pub. Date: Apr. 30, 2020

(54) SENSOR ELEMENT AND GAS SENSOR

(71) Applicant: NGK INSULATORS, LTD., Nagoya (JP)

(72) Inventors: Yusuke WATANABE, Nagoya (JP); Takayuki SEKIYA, Nagoya (JP)

(21) Appl. No.: 16/661,175

(22) Filed: Oct. 23, 2019

(30) Foreign Application Priority Data
Oct. 25, 2018 (JP) 2018-200869
Oct. 15, 2019 (JP) 2019-188886

(51) Int. Cl. G01N 27/407; G01N 27/41

(52) U.S. Cl. CPC G01N 27/4077; G01N 27/41

(57) ABSTRACT

In a sensor element that is used in a gas sensor capable of detecting an NH₃ concentration of a gas to be measured, an outer side electrode formed on a surface of the sensor element is covered with a porous protective layer having a density and thickness that prevent Pt from being released from the outer side electrode while allowing oxygen to pass from the gas to be measured to the outer side electrode, whereby adhesion of a substance having the ability to decompose NH₃ onto a protective cover is prevented.

### CROSS-REFERENCE TO RELATED APPLICATIONS

This application is based upon and claims the benefit of priority from Japanese Patent Applications No. 2018-200869 filed on Oct. 25, 2018 and No. 2019-188886 filed on Oct. 15, 2019, the contents all of which are incorporated herein by reference.

### BACKGROUND OF THE INVENTION

### Field of the Invention

The present invention relates to a sensor element and a gas sensor in which an oxygen ion conductive solid electrolyte is used.

### Description of the Related Art

Conventionally, gas sensors that measure the concentration of NO (nitrogen oxide), NH₃ (ammonia), and the like that coexist in the presence of oxygen, such as in an exhaust gas, have been proposed. Gas sensors of this type are covered with a protective cover that uniformly adjusts the flow of exhaust gas around the sensor element, together with preventing the adhesion thereto of condensed water that is generated when an engine is started.

However, when the gas sensor is used over a long period of time, the protective cover deteriorates, and components that are likely to undergo decomposition in the presence of oxygen such as NH₃ become decomposed within the protective cover, resulting in a decrease in the NH₃ detection sensitivity.

A method of eliminating such a decrease in NH₃ sensitivity of the gas sensor has been proposed. For example, in Japanese Laid-Open Patent Publication No. 2011-039041, it is disclosed that a coating layer for preventing reaction with NH₃ is provided on the surface of a protective cover made of stainless steel.

Further, in Japanese Laid-Open Patent Publication No. 2016-109693, it is disclosed that a surface area of the flow passage for a gas to be measured, which extends from a protective cover to a gas sensor, is set to be less than or equal to a predetermined value to thereby suppress the decomposition of NH₃ within an exhaust gas.

### SUMMARY OF THE INVENTION

However, even with the gas sensors described above, it has been ascertained that if the gas sensor is used over a long time period under a condition in which flowing of the gas to be measured is slow, there is a concern that the NH₃ detection sensitivity may be decreased depending on the condition.

Thus, an object of the present invention is to provide a sensor element and a gas sensor in which the NH₃ detection sensitivity is unlikely to be lowered, even if used over a long period of time under a condition in which flowing of the gas to be measured is slow.

One aspect of the present invention is characterized by a sensor element used in a gas sensor configured to detect an NH₃ concentration of a gas to be measured, the sensor element comprising a structural body comprising a solid electrolyte having oxygen ion conductivity, an outer side electrode disposed on an outer surface of the structural body, a porous protective layer covering the outer side electrode, an internal chamber provided inside the structural body, and an inner side electrode disposed in the internal chamber, wherein the outer side electrode includes a substance having an ability to decompose NH₃, and the porous protective layer prevents release of the substance having the ability to decompose NH₃ from the outer side electrode, while allowing oxygen to pass from the gas to be measured to the outer side electrode.

Another aspect of the present invention is characterized by a gas sensor comprising the above-described sensor element, and a protective cover that is configured to regulate inflow of the gas to be measured into the sensor element together with protecting the sensor element.

In the sensor element and the gas sensor having the above aspects, attention is focused on the substance having the ability to decompose NH₃ contained within the outer side electrode of the sensor element, and the outer side electrode is covered with the porous protective layer that prevents release of the substance having the ability to decompose NH₃. Consequently, it is possible to prevent the substance having the ability to decompose NH₃ contained within the outer side electrode from adhering to the protective cover, and a decrease in the NH₃ detection sensitivity can be prevented.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1A is a cross-sectional view of a gas sensor according to a first embodiment, and FIG. 1B is a front view of the gas sensor shown in FIG. 1A, wherein the cross-section of FIG. 1A is a cross-section of a portion indicated by line IA-IA in FIG. 1B;

FIG. 2 is a cross-sectional view of a sensor element of the gas sensor shown in FIG. 1A;

FIG. 3 is an enlarged cross-sectional view showing the vicinity of an outer side electrode of the sensor element of FIG. 2;

FIG. 4 is a table showing evaluation results of a rate of change in NH₃ sensitivity and a response time, in relation to Exemplary Embodiments 1 to 11 and Comparative Examples 1 to 5;

FIG. 5 is a graph showing measurement results of an operation time period in the atmosphere, and a rate of change in NH₃ detection sensitivity, in relation to the Exemplary Embodiments 1 to 11 and the Comparative Examples 1 to 5;

FIG. 6A is a cross-sectional view of a gas sensor according to a second embodiment; and

FIG. 6B is a front view of the gas sensor shown in FIG. 6A.

### DESCRIPTION OF THE PREFERRED EMBODIMENTS

A preferred embodiment of the present invention will be presented and described below with reference to the attached drawings. In the present specification, the term “to” when used to indicate a numerical range is used with the implication of including the numerical values written before and after the term as a lower limit value and an upper limit value of the numerical range.

### First Embodiment

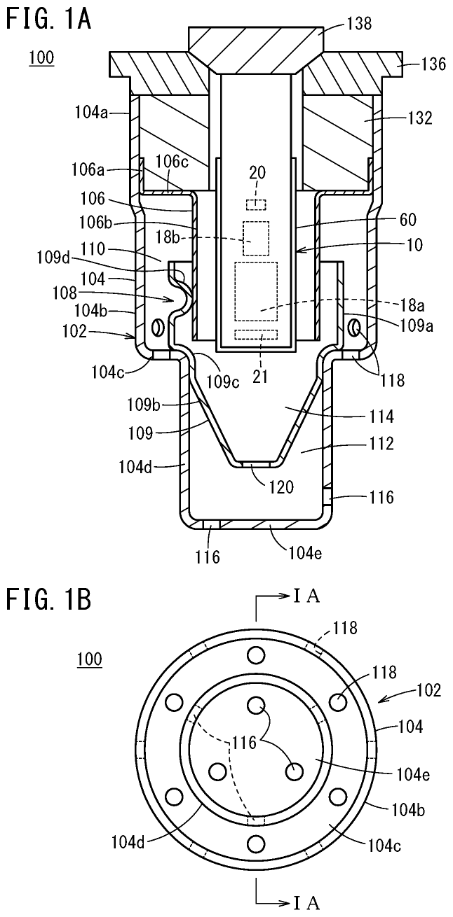

A gas sensor 100 according to the present embodiment, as shown in FIG. 1A, is used, for example, by being attached to a pipe through which an exhaust gas from an engine flows. The exhaust gas that is exhausted from the engine contains nitrogen oxide (hereinafter referred to as NO), and in order to make the NO harmless, an SCR (Selective Catalytic Reduction) device injects urea into the exhaust gas to thereby bring about a reaction with ammonia (hereinafter referred to as NH₃) that is generated by hydrolysis. The gas sensor 100, by detecting an excessive amount of NH₃ or NO, is used to control the amount of urea injected by the SCR device.

The gas sensor 100 comprises a sensor element 10 that detects the concentrations of NO and NH₃, a protective cover 102 that covers the periphery of the sensor element 10, a housing 132, a fixing member 136, and a sensor supporting member 138. The fixing member 136 is formed in a cylindrical shape, and is joined to an exhaust gas pipe (not shown) by means of welding or screwing. The housing 132 is a metal member formed in a cylindrical shape, and is joined to the fixing member 136. The protective cover 102 is attached to the outer periphery of the housing 132. The sensor supporting member 138 is joined to a central portion of the fixing member 136, and supports a proximal end part of the sensor element 10.

The protective cover 102 is disposed so as to surround the sensor element 10. The protective cover 102 includes a bottomed cylindrical inner side protective cover 108 that covers a distal end of the sensor element 10, and an outer side protective cover 104 that covers the inner side protective cover 108. Further, a first gas chamber 110 and a second gas chamber 112 are formed in a portion surrounded by the inner side protective cover 108 and the outer side protective cover 104, and a sensor element chamber 114 is formed inside the inner side protective cover 108. The protective cover 102 is formed of a metal, for example, stainless steel or the like.

The inner side protective cover 108 includes an inner side member 106 and an outer side member 109. The inner side member 106 includes a cylindrical large-diameter section 106a, a cylindrical small-diameter section 106b of a smaller diameter than the large-diameter section 106a, and a stepped portion 106c that interconnects the large-diameter section 106a and the small-diameter section 106b. The inner side member 106 is separated from the outside of the sensor element 10, and is disposed so as to surround a side portion of the sensor element 10.

The outer side member 109 includes a cylindrical tubular section 109a formed with a larger diameter than the small-diameter section 106b of the inner side member 106, a conical section 109b provided on a distal end side of the tubular section 109a, and an intermediate section 109c disposed between the tubular section 109a and the conical section 109b. The tubular section 109a is disposed so as to cover the outside of the small-diameter section 106b, and is in contact with the small-diameter section 106b of the inner side member 106 at a plurality of protrusions 109d provided in parts of the tubular section 109a so as to protrude inward in a radial direction. The intermediate section 109c is formed along the inner circumferential surface of a stepped portion 104c of the outer side protective cover 104, and the intermediate section 109c is in contact with the outer side protective cover 104. The conical section 109b is formed in a conical shape with a diameter decreasing toward the distal end side, and is disposed so as to cover the distal end side of the sensor element 10. A distal end side of the conical section 109b is formed in a flat shape, and a circular element chamber outlet 120, which enables communication between the second gas chamber 112 and the sensor element chamber 114, is formed in the distal end part of the conical section 109b.

A proximal end part of the inner side protective cover 108 is fixed to the housing 132 at the large-diameter section 106a of the inner side member 106. A gap between the inner side member 106 and the outer side member 109 of the inner side protective cover 108 forms a flow passage for the gas to be measured to the sensor element 10.

The outer side protective cover 104 comprises a cylindrical large-diameter section 104a, a cylindrical body section 104b formed integrally on a distal end side of the large-diameter section 104a, a stepped portion 104c which is formed on a distal end side of the body section 104b and is reduced in diameter in a radial inward direction, a cylindrical distal end portion 104d that extends from the stepped portion 104c to the distal end side, and a distal end surface 104e which is formed so as to close the distal end side of the distal end portion 104d. The outer side protective cover 104 is fixed to the housing 132 at the large-diameter section 104a.

As shown in FIG. 1B, on the body section 104b and the stepped portion 104c, six first gas chamber outlets 118, which enable communication between the exhaust gas pipe and the first gas chamber 110, are arranged respectively at intervals of roughly 60° in the circumferential direction. Further, on the distal end portion 104d and the distal end surface 104e, a plurality of second gas chamber outlets 116, which enable communication between the exhaust gas pipe and the second gas chamber 112, are provided. Thereamong, three of the second gas chamber outlets 116 are arranged on the distal end surface 104e at intervals of 120° in the circumferential direction. Further, on the distal end portion 104d as well, three of the second gas chamber outlets 116 are arranged at intervals of 120° in the circumferential direction. A configuration is provided in which the gas to be measured (for example, an exhaust gas) flowing from the first gas chamber outlets 118 and the second gas chamber outlets 116 passes through the first gas chamber 110, the second gas chamber 112, and the sensor element chamber 114 of the protective cover 102, and is directed to the sensor element 10.

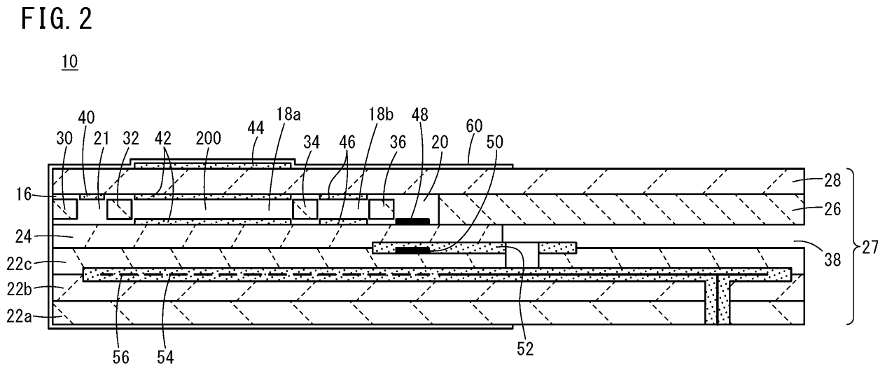

The sensor element 10 extends to a distal end side (downward in the drawing) of the gas sensor 100 through the fixing member 136 and a hollow portion of the housing 132. The sensor element 10 is an element that is formed in a thin elongated plate shape, and is produced by stacking layers of a solid electrolyte having oxygen ion conductivity such as zirconia (ZrO₂). More specifically, as shown in FIG. 2, the sensor element 10 includes a structural body 27 in which six layers, including a first substrate layer 22a, a second substrate layer 22b, a third substrate layer 22c, a first solid electrolyte layer 24, a spacer layer 26, and a second solid electrolyte layer 28 are stacked in this order from a lower side as viewed in the drawing. Each of these layers is constituted, respectively, from an oxygen ion conductive solid electrolyte such as zirconia (ZrO₂).

An internal chamber 200 is provided in the interior of the distal end side (the left side in FIG. 2) of the sensor element 10. The internal chamber 200 is disposed between a lower surface of the second solid electrolyte layer 28 and an upper surface of the first solid electrolyte layer 24. The internal chamber 200 includes a gas introduction port 16, a preliminary chamber 21, a main chamber 18a, an auxiliary chamber 18b, and a measurement chamber 20, which are arranged in this order from the side of the entrance toward the back.

The gas introduction port 16, the preliminary chamber 21, the main chamber 18a, the auxiliary chamber 18b, and the measurement chamber 20 are provided by hollowing out the spacer layer 26. Upper portions of all of the preliminary chamber 21, the main chamber 18a, the auxiliary chamber 18b, and the measurement chamber 20 are defined by the lower surface of the second solid electrolyte layer 28, and lower portions thereof are defined by the upper surface of the first solid electrolyte layer 24. The gas introduction port 16 is a portion that opens with respect to the external space, and the gas to be measured is drawn into the preliminary chamber 21 from the external space through the gas introduction port 16.

A first diffusion rate control member 30 is disposed between the gas introduction port 16 and the preliminary chamber 21. Further, a second diffusion rate control member 32 is disposed between the preliminary chamber 21 and the main chamber 18a. Furthermore, a third diffusion rate control member 34 is disposed between the main chamber 18a and the auxiliary chamber 18b, and a fourth diffusion rate control member 36 is disposed between the auxiliary chamber 18b and the measurement chamber 20.

All of the first diffusion rate control member 30, the third diffusion rate control member 34, and the fourth diffusion rate control member 36 are provided as two horizontally elongated slits (openings, the longitudinal direction of which is the depth direction of the sheet surface of the drawing). The second diffusion rate control member 32 is provided as one horizontally elongated slit (an opening, the longitudinal direction of which is the depth direction of the sheet surface of the drawing).

The first diffusion rate control member 30 is a portion that imparts a predetermined diffusion resistance to the gas to be measured which is introduced from the gas introduction port 16 into the preliminary chamber 21. The second diffusion rate control member 32 is a portion that imparts a predetermined diffusion resistance to the gas to be measured which is introduced from the preliminary chamber 21 into the main chamber 18a. The third diffusion rate control member 34 is a portion that imparts a predetermined diffusion resistance to the gas to be measured which is introduced from the main chamber 18a into the auxiliary chamber 18b. The fourth diffusion rate control member 36 is a portion that imparts a predetermined diffusion resistance to the gas to be measured which is introduced from the auxiliary chamber 18b into the measurement chamber 20.

A preliminary pump electrode 40 is provided in the preliminary chamber 21, a main pump electrode 42 is provided in the main chamber 18a, an auxiliary pump electrode 46 is provided in the auxiliary chamber 18b, and a measurement pump electrode 48 is provided in the measurement chamber 20. Further, an outer side electrode 44 is formed at a portion corresponding to the main pump electrode 42, on an upper surface of the second solid electrolyte layer 28 that defines the outer surface of the structural body 27. The outer side electrode 44 is formed in substantially the same planar shape as the main pump electrode 42.

A configuration is provided in which, by a predetermined current flowing between the outer side electrode 44, the preliminary pump electrode 40, the main pump electrode 42, the auxiliary pump electrode 46, and the measurement pump electrode 48, oxygen can be pumped into the respective chambers, or oxygen can be pumped out from the respective chambers via the second solid electrolyte layer 28. The preliminary pump electrode 40 is made of a porous cermet electrode containing a material such as gold (Au) having a low reactivity with NH₃ and a low NO reduction ability. The outer side electrode 44 and the main pump electrode 42 are made of a porous cermet electrode containing a material such as platinum (Pt) having a low NOx reduction ability. The measurement pump electrode 48 is made of a cermet electrode containing a material such as rhodium (Rh) having a NOx reduction ability. An inner side electrode of the present embodiment is constituted by the preliminary pump electrode 40, the main pump electrode 42, the auxiliary pump electrode 46, and the measurement pump electrode 48.

Further, a reference gas introduction space 38 is disposed between an upper surface of the third substrate layer 22c and a lower surface of the spacer layer 26, and on a proximal end side of the internal chamber 200. The reference gas introduction space 38 is an internal space in which an upper part thereof is defined by the lower surface of the spacer layer 26, a lower part thereof is defined by the upper surface of the third substrate layer 22c, and a side part thereof is defined by a side surface of the first solid electrolyte layer 24. For example, air is introduced as a reference gas into the reference gas introduction space 38. A reference electrode 50 is provided on an innermost side of the reference gas introduction space 38. The reference electrode 50 is disposed in a manner so as to be covered with a porous ceramic layer 52.

Measurement of the NOx concentration by the sensor element 10 is primarily performed by the measurement pump electrode 48 that is provided in the measurement chamber 20. The NOx in the gas to be measured which is introduced into the measurement chamber 20 is reduced inside the measurement chamber 20 and decomposed into N₂ and O₂. The measurement pump electrode 48 pumps out 02 generated by decomposition of NOx, and detects the generated amount of the O₂ as a measurement pump current Ip3, that is, as a sensor output. At this time, the main chamber 18a and the auxiliary chamber 18b operate so as to adjust the oxygen concentration of the gas to be measured to a constant value. In the preliminary chamber 21, by switching the operative state of the preliminary pump electrode 40 at regular time intervals, it is possible to determine the NO concentration and the NH₃ concentration separately.

Further, in the sensor element 10, a heater 54 is formed in a manner of being sandwiched from above and below between the second substrate layer 22b and the third substrate layer 22c. The heater 54 generates heat by being supplied with power from the exterior through a non-illustrated heater electrode provided on a lower surface of the first substrate layer 22a. The heater 54 is formed over the entire area of the preliminary chamber 21, the main chamber 18a, and the auxiliary chamber 18b, and is capable of maintaining a predetermined location of the sensor element 10 at a predetermined temperature (for example, greater than or equal to 800° C.). Further, a heater insulating layer 56 made of alumina or the like is formed above and below the heater 54, for the purpose of obtaining electrical insulation thereof from the second substrate layer 22b and the third substrate layer 22c.

Furthermore, the distal end of the sensor element 10 is covered with a porous protective layer 60. The porous protective layer 60 is formed in a manner so as to cover the upper surface of the second solid electrolyte layer 28 of the sensor element 10, the lower surface of the first substrate layer 22a, a distal end surface of the sensor element 10, and side surfaces of the sensor element 10. The porous protective layer 60 is formed in a manner so as to cover the entire area of the outer side electrode 44. In addition, in order to supply the oxygen that is pumped into the internal chamber 200 by the outer side electrode 44, the porous protective layer 60 is made of a porous ceramic through which oxygen is capable of passing.

Also in a conventional sensor element, with the goal of preventing moisture in the gas to be measured from adhering to the sensor element and preventing cracks from occurring in the sensor element, and with the goal of preventing hydrocarbons such as oil in the gas to be measured from adhering to the outer side electrode, in certain cases, a coating layer is provided to cover the sensor element. However, with the conventional coating layer, when the gas sensor is used under a condition of high temperature over a long period of time, the release of Pt from the outer side electrode cannot be sufficiently prevented, and it cannot be prevented that the protective cover will become covered by Pt which has a high ability to decompose NH₃ when the flow velocity of the gas to be measured is low.

Thus, according to the present embodiment, the outer side electrode 44 is covered with the porous protective layer 60 having a density and thickness that are capable of preventing the release of Pt from the outer side electrode 44 over a long period of time. When the outer side electrode 44 is used over a long period of time, a portion thereof is oxidized into platinum oxide (PtO). PtO has a high vapor pressure, and becomes volatilized even at a relatively low temperature on the order of 300° C. The porous protective layer 60 of the present embodiment is configured in a manner so as to be capable of enclosing such highly volatile PtO.

More specifically, under a condition in which the sensor element 10 is set to a normal operating temperature of 800° C., a gas to be measured having an oxygen concentration of 1000 ppm is flowing, and a voltage of 500 mV is applied between the outer side electrode 44 and the inner side electrode (the preliminary pump electrode 40, the main pump electrode 42, the auxiliary pump electrode 46, and the measurement pump electrode 48), the porous protective layer 60 preferably has a density and thickness of a degree whereby the limit current density flowing within a unit area of the outer side electrode 44 becomes less than or equal to 270 μA/mm². If the porous protective layer 60 is used having a combined density and thickness that allows only oxygen to pass, which is of a degree whereby the limit current density flowing to the outer side electrode 44 is limited to being less than or equal to 270 μA/mm², release of a substance having the ability to decompose NH₃ such as Pt from the outer side electrode 44 can be prevented. With the porous protective layer 60 in which the limit current density flowing to the outer side electrode 44 significantly exceeds 270 μA/mm², although the response speed of the sensor element 10 is improved, in the case of being used over long period of time, release of Pt or the like from the outer side electrode 44 cannot be prevented, and the NH₃ detection sensitivity is disadvantageously lowered.

When the density and thickness of the porous protective layer 60 is increased so that the limit current density flowing to the outer side electrode 44 is less than 270 μA/mm², it is preferable since the release of Pt or the like from the outer side electrode 44 can be prevented more effectively. However, if the limit current density flowing to the outer side electrode 44 is made too small, the response speed of the output of the sensor element 10 with respect to changes in the concentration of the gas to be measured becomes slow. From the standpoint of setting the response time to be less than or equal to 300 ms, which is a practical criterion in measuring the exhaust gas when the gas to be measured is made to change in a binary manner from a predetermined high concentration value to a predetermined low concentration value, it is preferable for the density and thickness of the porous protective layer 60 to be set so that the limit current density flowing to the outer side electrode 44 is greater than or equal to 15 μA/mm². Moreover, in the case of being used for a purpose in which the slow response speed is acceptable, the limit current density provided by the porous protective layer 60 may be less than 15 μA/mm².

From the standpoint of realizing both the long-term durability of the gas sensor 100 and the response speed of the sensor element 10, it is preferable to use the porous protective layer 60 having a density and thickness whereby the limit current density flowing to the outer side electrode 44 is on the order of 70 μA/mm².

The above-described porous protective layer 60 can be constituted, for example, by an alumina porous body, a zirconia porous body, a spinel porous body, a cordierite porous body, a magnesia porous body, or a titania porous body. Further, the porosity of the porous protective layer 60 can be 10% to 25%, and the thickness thereof can be 200 to 600 μm.

Such a porous protective layer 60 can be formed by supplying a ceramic powder such as alumina together with a carrier gas to a plasma gun, and spraying the substance onto the surface of the sensor element 10. Moreover, the porous protective layer 60 can also be formed by a method in which the sensor element 10 is immersed in a solution containing a ceramic powder and a binder, and thereafter subjected to firing. Further, the porous protective layer 60 may be formed by a CVD method, a PVD method, or the like.

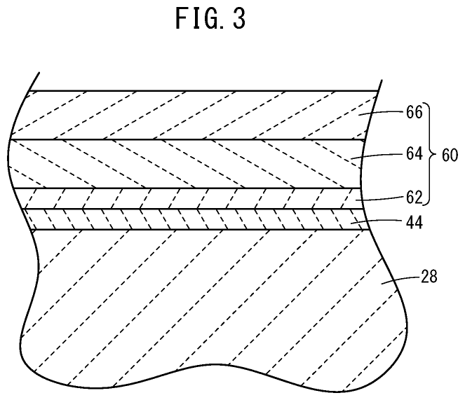

Further, the porous protective layer 60 may have a multilayer structure in order to improve adhesion. More specifically, the porous protective layer 60 shown in FIG. 3 comprises a three-layer structure including an inner side protective layer 62 formed on the outer side electrode 44, an intermediate protective layer 64 formed on the inner side protective layer 62, and an outer side protective layer 66 formed on the intermediate protective layer 64.

The inner side protective layer 62 is constituted, for example, by an alumina porous body, a zirconia porous body, a spinel porous body, a cordierite porous body, a magnesia porous body, or a titania porous body. The porosity of the inner side protective layer 62 is 20% to 50%, and the thickness thereof is 10 to 300 μm. The inner side protective layer 62 is preferably constituted by a film having a relatively large porosity and exhibiting good adhesion with the outer side electrode 44 and the second solid electrolyte layer 28.

The intermediate protective layer 64 can be constituted by a porous body made of the same material as that of the inner side protective layer 62, and can have a porosity of 25% to 80% and a thickness of 100 to 700 μm. The intermediate protective layer 64 is constituted by a material having a density lower than that of at least the outer side protective layer 66. Further, the intermediate protective layer 64 may be constituted by a material having an intermediate density between that of the inner side protective layer 62 and the outer side protective layer 66, and in this case, peeling of the outer side protective layer 66 can be prevented. Moreover, the porous protective layer 60 may be constituted by only two layers including the outer side protective layer 66 and the inner side protective layer 62, without providing the intermediate protective layer 64. Furthermore, the intermediate protective layer 64 may be constituted by a material having a lower density than that of the inner side protective layer 62, and the thickness of the intermediate protective layer 64 may be formed to be thicker than that of the outer side protective layer 66.

The outer side protective layer 66 can be constituted by a porous body made of the same material as that of the inner side protective layer 62, and can have a porosity of 10% to 25% and a thickness of 200 to 600 μm. The outer side protective layer 66 is preferably formed as a dense protective layer having a smaller porosity than that of the inner side protective layer 62. Further, the outer side protective layer 66 is preferably formed to be thicker than the inner side protective layer 62.

In the porous protective layer 60 having a multilayer structure as described above, in accordance with the total thickness and density of the inner side protective layer 62, the intermediate protective layer 64, and the outer side protective layer 66, it is sufficient for the limit current density flowing to the outer side electrode 44 to be less than or equal to 270 μA/mm².

Further, from the standpoint of suppressing the amount of Pt released from the outer side electrode 44, it is preferable for the area of the outer side electrode 44 to be held down below a certain level when the porous protective layer 60 is provided. For example, when the area of the outer side electrode 44 is held to less than or equal to 10 mm², the long-term reliability of the gas sensor 100 is improved. However, if the area of the outer side electrode 44 is too small, the response speed of the sensor element 10 will be reduced. Thus, from the standpoint of obtaining a response time of less than or equal to 300 ms, which is a practical criterion when measuring the exhaust gas, the area of the outer side electrode 44 is preferably greater than or equal to 5 mm².

Furthermore, in the sensor element 10, noble metals having the ability to decompose NH₃ such as platinum (Pt) and rhodium (Rh) are preferably used as the material for the inner side electrode, to thereby prevent the release of a substance having the ability to decompose NH₃ from the inner side electrode. From the standpoint of preventing the release of a substance having the ability to decompose NH₃ from the inner side electrode, it is preferable to restrain the area of the opening of the gas introduction port 16 and the diffusion rate control member of the internal chamber 200. The amount of the substance having the ability to decompose NH₃ that is released through the gas introduction port 16 and the diffusion rate control member can be evaluated by the limit current density per unit area of the inner side electrode that flows when a voltage of 500 mV is applied in a direction in which oxygen is transported from the inner side electrode to the outer side electrode 44, while the gas to be measured containing 1000 ppm of oxygen is contacted. In the present embodiment, it is preferable for the gas introduction port 16 and the diffusion rate control member to be configured so that the limit current density flowing between the inner side electrode and the outer side electrode 44 lies within a range of from 0.5 to 3.0 μA/mm². Further, if a ratio A/B between the limit current density A when a voltage is applied in a direction in which oxygen ions flow from the outer side electrode 44 to the inner side electrode, and the limit current density B when a voltage is applied flowing in a direction in which oxygen ions flow from the inner side electrode to the outer side electrode 44 ranges from 10 to 300, it is preferable since the long-term reliability of the gas sensor 100 and the response speed of the sensor element 10 can both be realized.

### Exemplary Embodiments

### Exemplary Embodiments 1 to 11 and Comparative Examples 1 to 5

Hereinafter, various sensor elements 10 and gas sensors 100 produced according to Exemplary Embodiments and Comparative Examples, in which porous protective layers 60 having different porosities and thicknesses are formed, and the results of evaluations performed thereon, will be described. In a first evaluation, after the gas sensor 100 was driven over a period of 3000 hours in an atmosphere and at the same temperature (800° C.) as during actual use, the NH₃ detection sensitivity ratio of the sensor element 10 was measured. A rate of change of less than or equal to −20% was determined to be acceptable, whereas a rate of change in excess of −20% was determined to be defective (Determination 1). Details of the first evaluation are the same as those described in paragraph [0080] of Japanese Laid-Open Patent Publication No. 2016-109693. More specifically, a value of the measurement pump current Ip3 at a time that a mixed gas (an NH₃ containing gas) containing 100 ppm of NH₃ and 0.5% of O₂ flowed, and a value of the measurement pump current Ip3 at a time that a mixed gas (an NO containing gas) containing 100 ppm of NO and 0.5% of O₂ flowed, were acquired. In addition, a ratio (%) of the measurement pump current Ip3 at the time that the NH₃ containing gas flowed to the measurement pump current Ip3 at the time that the NO containing gas flowed was obtained as an evaluation value according to the first evaluation.

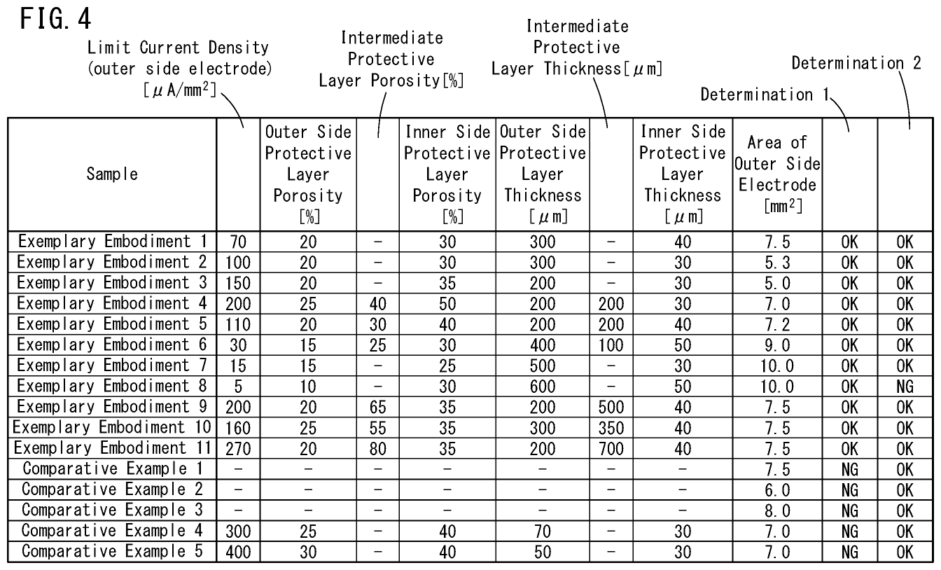

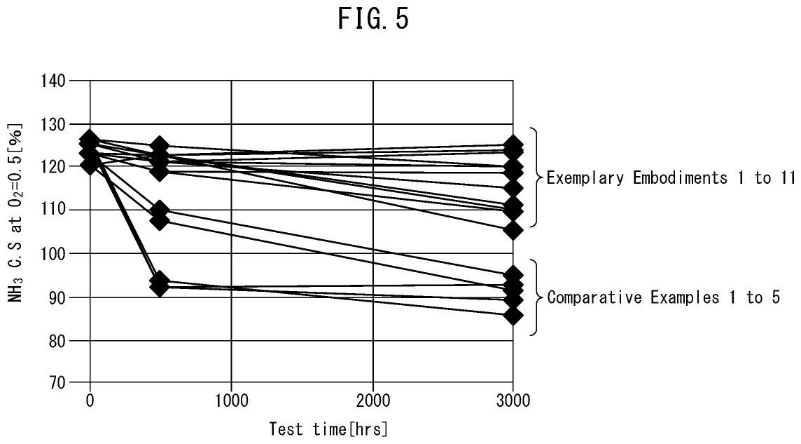

The configurations of respective samples according to Exemplary Embodiments 1 to 11 and Comparative Examples 1 to 5 are shown in FIG. 4. Further, the evaluation results of the first evaluation are shown in FIG. 5. In FIG. 5, the vertical axis indicates a ratio (an evaluation value (%) according to the first evaluation) of the measurement pump current Ip3 at the time that the NH₃ containing gas flowed to the measurement pump current Ip3 at the time that the NO containing gas flowed. As shown in FIG. 5, in all of the samples, the evaluation value (%) according to the first evaluation tends to decrease along with the elapse of time. The reason as to why the evaluation value decreases is because the measurement pump current Ip3 when the NH₃ containing gas flowed decreases over time. The decrease of the measurement pump current Ip3 when the NH₃ containing gas flowed occurs due to the fact that, by platinum becoming adhered to the protective cover, a decomposition reaction of NH₃ is generated, and before the NH₃ molecules arrive at the internal space of the NOx sensor, the NH₃ becomes decomposed within the protective cover.

Further, in a second evaluation, the response speeds of the sensor elements 10 according to Exemplary Embodiments and Comparative Examples were evaluated. The response time of the sensor element 10 when switching was performed in a binary manner from a gas to be measured having a relatively high NO concentration and NH₃ concentration to a gas to be measured having a relatively low NO concentration and NH₃ concentration was measured. A response time of less than or equal to 300 ms was determined to be acceptable, whereas a response time in excess of 300 ms was determined to be defective (Determination 2).

In FIGS. 4 and 5, as shown in Exemplary Embodiments 1 to 11, in the case that the porous protective layer 60 in which the value of the limit current density of the outer side electrode 44 is less than or equal to 270 μA/mm² is formed, it is understood that, even if driven over a period of 3000 hours, the NH₃ detection sensitivity does not decrease and the long-term reliability is excellent. Further, in the case of the limit current density of the outer side electrode 44 being greater than or equal to 15 μA/mm², it is understood that the response time ends up being less than or equal to 300 ms, and a favorable response speed as a gas sensor 100 for exhaust gas is obtained.

Moreover, as shown in Exemplary Embodiment 8, in the case that the porous protective layer 60 in which the value of the limit current density of the outer side electrode 44 is 5 μA/mm² is formed, although the NH₃ detection sensitivity did not decrease and durability was excellent, the response time exceeded 300 ms, and thus the response speed was determined to be slightly insufficient for exhaust gas measurement. Accordingly, from the standpoint of ensuring a response speed suitable for exhaust gas measurement, it is understood to be preferable for the outer side electrode 44 to be configured to allow passage of oxygen of an amount with which the limit current density is greater than or equal to 15 μA/mm².

On the other hand, as shown in Comparative Examples 1 to 3 of FIG. 4, in the case that the porous protective layer is not provided, the rate of change in the NH₃ detection sensitivity of the gas sensor 100 after driven over a period of 3000 hours exceeded −20% as shown in FIG. 5, and sufficient durability could not be obtained.

Further, as shown in Comparative Examples 4 and 5 of FIG. 4, even in the case that the porous protective layer is provided, if the limit current density significantly exceeds 270 μA/mm², then as shown in FIG. 5, the NH₃ detection sensitivity decreased along with the elapse of time, and the rate of change in the NH₃ detection sensitivity after 3000 hours exceeded −20%, so that sufficient durability could not be obtained.

In contrast thereto, in Exemplary Embodiments 1 to 11, as shown in FIG. 5, it could be confirmed that the rate of change in the NH₃ detection sensitivity after an elapse of 3000 hours is only on the order of −10%, and the gas sensor 100 which is excellent in terms of long-term durability can be realized.

The sensor element 10 and the gas sensor 100 described above exhibit the following advantageous effects.

In the gas sensor 100 and the sensor element 10, by regulating the passage of oxygen from the gas to be measured to the outer side electrode 44, the porous protective layer 60 regulates a limit current density to be less than or equal to 270 μA/mm², the limit current density being generated by oxygen ions flowing from the outer side electrode 44 toward the inner side electrode at a time that a voltage of 500 mV is applied between the outer side electrode 44 and the inner side electrode under a condition in which the gas to be measured has an oxygen concentration of 1000 ppm. Due to the porous protective layer 60 having the above-described limit current density, it is possible to suppress the release of the substance having the ability to decompose NH₃ from the outer side electrode 44, and a decrease in the NH₃ detection sensitivity of the gas sensor 100 can be prevented.

In the gas sensor 100 and the sensor element 10, the porous protective layer 60 may have a density and thickness that allow the passage of oxygen in an amount by which the limit current density flowing to the outer side electrode 44 and the inner side electrode becomes greater than or equal to 15 μA/mm². Consequently, a response speed suitable for practical use as an exhaust gas sensor can be imparted to the sensor element 10.

In the gas sensor 100 and the sensor element 10, the porous protective layer 60 comprises two or more protective layers of different porosities, and the porosity of the outer side protective layer 66 may be smaller than the porosity of the inner side protective layer 62, and the thickness of the outer side protective layer 66 may be greater than the thickness of the inner side protective layer 62.

In the gas sensor 100 and the sensor element 10, the porous protective layer 60 may include the outer side protective layer 66 that is formed on the outermost layer and has a porosity of 10% to 25%, and the inner side protective layer 62 that is formed on the outer side electrode 44 and has a porosity of 20% to 50%. Such a configuration is preferable since the adhesiveness of the porous protective layer 60 can be enhanced, and peeling of the porous protective layer 60 can be prevented.

In the gas sensor 100 and the sensor element 10, the porous protective layer 60 may have a multilayer structure in which the thickness of the outer side protective layer 66 is 200 to 600 μm, and the thickness of the inner side protective layer 62 is 10 to 300 μm. Such a configuration is preferable since peeling of the outer side protective layer 66 can be prevented.

In the gas sensor 100 and the sensor element 10, the area of the outer side electrode 44 may be 5 to 10 mm². By setting the area of the outer side electrode 44 within the aforementioned range, it is possible to suppress the release of the substance having the ability to decompose NH₃ from the outer side electrode 44, without sacrificing the response speed of the sensor element 10.

In the gas sensor 100 and the sensor element 10, a configuration may be provided in which, when a voltage of 500 mV is applied between the outer side electrode 44 and the inner side electrode under a condition in which the gas to be measured has an oxygen concentration of 1000 ppm, the limit current density flowing from the inner side electrode toward the outer side electrode 44 may be 0.5 to 3.0 μA/mm². In accordance with such a configuration, it is possible to suppress the release of the substance having the ability to decompose NH₃ such as Pt contained within the inner side electrode, without sacrificing the response speed of the sensor element 10.

In the gas sensor 100 and the sensor element 10, a configuration may be provided in which the ratio A/B between the limit current density A flowing from the outer side electrode 44 toward the inner side electrode, and the limit current density B flowing from the inner side electrode toward the outer side electrode 44 may range from 10 to 300. In accordance with such a configuration, the release of the substance having the ability to decompose NH₃, such as Pt contained within the inner side electrode, can be suppressed, and a decrease in the NH₃ detection sensitivity of the gas sensor 100 can be suppressed.

In the gas sensor 100 and the sensor element 10, the substance having the ability to decompose NH₃ and released from the sensor element 10 may be Pt (platinum). Pt is oxidized into highly volatile PtO while the gas sensor 100 is driven over a long period of time, and is likely to be gradually released from the sensor element 10. To address this problem, the sensor element 10 of the present embodiment includes the porous protective layer 60 having a predetermined density and thickness, whereby it is possible to suppress the release of Pt over a long time period.

### Second Embodiment

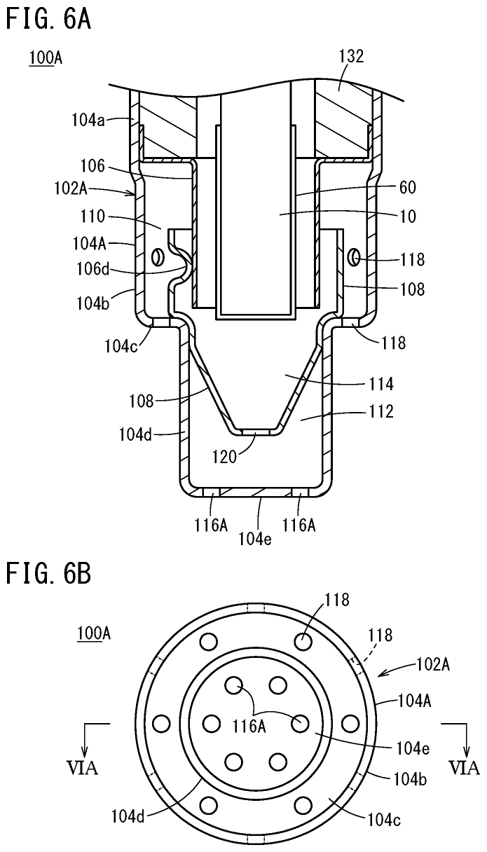

As shown in FIGS. 6A and 6B, a gas sensor 100A of the present embodiment differs from the gas sensor 100 shown in FIGS. 1A and 1B, in that the gas sensor 100A is equipped with an outer side protective cover 104A in which the arrangement of the second gas chamber outlets 116 is changed. In the gas sensor 100A, the same constituent elements as those in the gas sensor 100 are denoted with the same reference numerals, and detailed description thereof is omitted.

A cover body 102A of the gas sensor 100A includes an outer side protective cover 104A and the inner side protective cover 108. The outer side protective cover 104A comprises a cylindrical large-diameter section 104a, a cylindrical body section 104b formed integrally on a distal end side of the large-diameter section 104a, a stepped portion 104c which is formed on a distal end side of the body section 104b and is reduced in diameter in a radial inward direction, a cylindrical distal end portion 104d that extends from the stepped portion 104c to the distal end side, and a distal end surface 104e which is formed so as to close the distal end side of the distal end portion 104d. The outer side protective cover 104A is fixed to the housing 132 at the large-diameter section 104a.

On the distal end surface 104e of the outer side protective cover 104A, first exhaust gas outlets 116A, which enable communication between the second gas chamber 112 and an exhaust gas pipe (not shown), are provided. Six first exhaust gas outlets 116A are formed on the distal end surface 104e at angular intervals of 60° in the circumferential direction around the axis of the outer side protective cover 104A. Moreover, a configuration is provided in which the first exhaust gas outlets 116A are not provided on the distal end portion 104d of the outer side protective cover 104A, and the gas to be measured flows into the second gas chamber 112 only from the distal end surface 104e.

As described above, according to the gas sensor 100A of the present embodiment as well, the same effects as those of the gas sensor 100 according to the first embodiment can be obtained.

Although the present invention has been described above by way of preferred embodiments, the present invention is not limited to the above-described embodiments, and it goes without saying that various modifications can be made within a range that does not depart from the essence and gist of the present invention.

What is claimed is:

1. A sensor element used in a gas sensor configured to detect an NH₃ (ammonia) concentration of a gas to be measured, the sensor element comprising:
a structural body comprising a solid electrolyte having oxygen ion conductivity;
an outer side electrode disposed on an outer surface of the structural body;
a porous protective layer covering the outer side electrode;
an internal chamber provided inside the structural body; and
an inner side electrode disposed in the internal chamber,
wherein the outer side electrode includes a substance having an ability to decompose NH₃, and
the porous protective layer prevents release of the substance having the ability to decompose NH₃ from the outer side electrode, while allowing oxygen to pass from the gas to be measured to the outer side electrode.

2. The sensor element according to claim 1, wherein, by regulating passage of oxygen from the gas to be measured to the outer side electrode, the porous protective layer regulates a limit current density to be less than or equal to 270 μA/mm², the limit current density being generated by oxygen ions flowing from the outer side electrode toward the inner side electrode at a time that a voltage of 500 mV is applied between the outer side electrode and the inner side electrode under a condition in which the gas to be measured has an oxygen concentration of 1000 ppm.

3. The sensor element according to claim 2, wherein the porous protective layer allows the passage of oxygen in an amount by which the limit current density flowing to the outer side electrode and the inner side electrode becomes greater than or equal to 15 μA/mm².

4. The sensor element according to claim 1, wherein the porous protective layer comprises two or more protective layers of different porosities, a porosity of an outer side protective layer is smaller than a porosity of an inner side protective layer, and a thickness of the outer side protective layer is greater than a thickness of the inner side protective layer.

5. The sensor element according to claim 4, wherein the porous protective layer includes an outer side protective layer formed on an outermost layer and having a porosity of 10% to 25%, and an inner side protective layer formed on the outer side electrode and having a porosity of 20% to 50%.

6. The sensor element according to claim 5, wherein a thickness of the outer side protective layer is 200 to 600 μm, and a thickness of the inner side protective layer is 10 to 300 μm.

7. The sensor element according to claim 1, wherein an area of the outer side electrode is 5 to 10 mm².

8. The sensor element according to claim 1, wherein the porous protective layer includes an inner side protective layer formed on the outer side electrode and having a porosity of 20% to 50%, an intermediate protective layer formed on the inner side protective layer and having a porosity of 25% to 80%, and an outer side protective layer formed on the intermediate protective layer and having a porosity of 10% to 25%, the intermediate protective layer having a thickness of 100 to 700 μm.

9. The sensor element according to claim 2, wherein, when a voltage of 500 mV is applied between the outer side electrode and the inner side electrode under a condition in which the gas to be measured has an oxygen concentration of 1000 ppm, the limit current density flowing from the inner side electrode toward the outer side electrode is 0.5 to 3.0 μA/mm².

10. The sensor element according to claim 9, wherein a ratio A/B between a limit current density A flowing from the outer side electrode toward the inner side electrode, and a limit current density B flowing from the inner side electrode toward the outer side electrode ranges from 10 to 300.

11. The sensor element according to claim 1, wherein the substance having the ability to decompose NH₃ is Pt (platinum).

12. A gas sensor comprising:
a sensor element configured to detect an NH₃ (ammonia) concentration of a gas to be measured; and
a protective cover configured to regulate inflow of the gas to be measured into the sensor element together with protecting the sensor element,
wherein the sensor element comprises:
a structural body comprising a solid electrolyte having oxygen ion conductivity;
an outer side electrode disposed on an outer surface of the structural body;
a porous protective layer covering the outer side electrode;
an internal chamber provided inside the structural body; and
an inner side electrode disposed in the internal chamber, and
wherein the outer side electrode includes a substance having an ability to decompose NH₃, and
the porous protective layer prevents release of the substance having the ability to decompose NH₃ from the outer side electrode, while allowing oxygen to pass from the gas to be measured to the outer side electrode.

13. The gas sensor according to claim 12, wherein, by regulating passage of oxygen from the gas to be measured to the outer side electrode, the porous protective layer regulates a limit current density to be less than or equal to 270 μA/mm², the limit current density being generated by oxygen ions flowing from the outer side electrode toward the inner side electrode at a time that a voltage of 500 mV is applied between the outer side electrode and the inner side electrode under a condition in which the gas to be measured has an oxygen concentration of 1000 ppm.

14. The gas sensor according to claim 13, wherein the porous protective layer allows the passage of oxygen in an amount by which the limit current density flowing to the outer side electrode and the inner side electrode becomes greater than or equal to 15 μA/mm².

15. The gas sensor according to claim 12, wherein the porous protective layer comprises two or more protective layers of different porosities, a porosity of an outer side protective layer is smaller than a porosity of an inner side protective layer, and a thickness of the outer side protective layer is greater than a thickness of the inner side protective layer.

16. The gas sensor according to claim 15, wherein the porous protective layer includes an outer side protective layer formed on an outermost layer and having a porosity of 10% to 25%, and an inner side protective layer formed on the outer side electrode and having a porosity of 20% to 50%.

17. The gas sensor according to claim 16, wherein a thickness of the outer side protective layer is 200 to 600 μm, and a thickness of the inner side protective layer is 10 to 300 μm.

18. The gas sensor according to claim 12, wherein the porous protective layer includes an inner side protective layer formed on the outer side electrode and having a porosity of 20% to 50%, an intermediate protective layer formed on the inner side protective layer and having a porosity of 25% to 80%, and an outer side protective layer formed on the intermediate protective layer and having a porosity of 10% to 25%, the intermediate protective layer having a thickness of 100 to 700 μm.

19. The gas sensor according to claim 12, wherein an area of the outer side electrode is 5 to 10 mm².

20. The gas sensor according to claim 13, wherein, when a voltage of 500 mV is applied between the outer side electrode and the inner side electrode under a condition in which the gas to be measured has an oxygen concentration of 1000 ppm, the limit current density flowing from the inner side electrode toward the outer side electrode is 0.5 to 3.0 μA/mm².

21. The gas sensor according to claim 20, wherein a ratio A/B between a limit current density A flowing from the outer side electrode toward the inner side electrode, and a limit current density B flowing from the inner side electrode toward the outer side electrode ranges from 10 to 300.

22. The gas sensor according to claim 12, wherein the substance having the ability to decompose NH₃ is Pt (platinum).
